(19) United States
(12) Patent Application Publication
(10) Pub. No.: US 2009/0115497 A1
(43) Pub. Date: May 7, 2009

(54) POWER SOURCE CIRCUIT

(75) Inventor: Yoshikazu TAKEYAMA, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 12/348,210

(22) Filed: Jan. 2, 2009

Related U.S. Application Data
(63) Continuation of application No. 12/122,216, filed on May 16, 2008, now abandoned.

(30) Foreign Application Priority Data
May 16, 2007 (JP) 2007-130627

(51) Int. Cl. G05F 3/02

(52) U.S. Cl. 327/536

(57) ABSTRACT

A power source circuit that outputs a designated voltage through an output terminal thereof, comprising: a step-up circuit that steps up a voltage fed from a power supply and applies the resultant voltage to the output terminal; a voltage sensing circuit that senses a voltage outputted from the step-up circuit and outputs a signal with which activation of the step-up circuit is controlled; and a filter circuit that includes a variable resistor connected between the output side of the step-up circuit and the output terminal.

### CROSS-REFERENCE TO RELATED APPLICATIONS

This application is a continuation of and claims the benefit of priority under 35 U.S.C. §120 from U.S. application Ser. No. 12/122,216, filed May 16, 2008, and claims the benefit of priority under 35 U.S.C. §119 from Japanese Patent Application No. 2007-130627, filed May 16, 2007, the entire contents of each are incorporated herein by reference.

### BACKGROUND OF THE INVENTION

1. Field of the Invention

The present invention relates to a power source circuit including a step-up circuit that steps up a supply voltage.

2. Description of the Related Art

Conventionally, a semiconductor memory unit such as a NAND type flash memory includes a power source circuit that uses a step-up circuit to step up a supply voltage and feeds the resultant voltage. For example, the semiconductor memory unit such as the NAND type flash memory needs a voltage, which is higher than the supply voltage, so as to perform an operation of writing, erasing, or reading data. Consequently, the semiconductor memory unit includes the step-up circuit that steps up the supply voltage and a voltage sensing circuit that retains the voltage at a designated voltage. The step-up circuit has a MOS transistor and a capacitor connected in series with each other, has complementary clocks CLK and CLKB applied to one terminal of the capacitor, and steps up the supply voltage.

Moreover, the voltage sensing circuit includes a voltage division circuit and a comparative amplifier. The output terminal of the step-up circuit and the ground are connected in series with each other via the voltage division circuit. The comparative amplifier compares a monitor voltage outputted from the voltage division circuit with a reference voltage.

In a case where a voltage level to be sensed by the voltage sensing circuit is changed from one to another, multiple n-type MOS transistors whose sources are grounded are connected to nodes of voltage division resistors included in the voltage division circuit, and selection signals are applied to the respective gates so that a voltage designated for the output of the step-up circuit is determined with the selection signals. When the output of the step-up circuit is lower than the designated voltage, the monitor voltage becomes lower than the reference voltage, and the comparative amplifier switches the output thereof to, for example, a high level. With the output, the step-up circuit is activated. The output of the step-up circuit is stepped up synchronously with the clock CLK or CLKB.

In contrast, when the output of the step-up circuit is higher than the designated voltage, the monitor voltage becomes higher than the reference voltage, and the output of the comparative amplifier is switched to, for example, a low level. With the output, the step-up circuit is inactivated. The clocks CLK and CLKB are blocked in order to cease the step-up operation of the step-up circuit.

As mentioned above, since the voltage sensing circuit activates or inactivates the step-up circuit, the output of the step-up circuit can be retained at a voltage close to the designated voltage.

Incidentally, in the foregoing step-up operation, the output voltage is not retained at a certain voltage but vibrates around the designated voltage. This phenomenon is referred to as a ripple. The ripple increases or decreases depending on an RC constant which is based on the resistance value of the voltage division resistors, an operational delay of the comparative amplifier, and the step-up ability of the step-up circuit. When the resistance value of the voltage division resistors is large, when the operational delay of the comparative amplifier is large, or when the step-up ability of the step-up circuit is high, the ripper increases.

In the operation of writing data in a cell of an NAND type flash memory, if the ripple occurring on a word line on which a selected cell and unselected cells are connected is large, the threshold voltage of the written cell expands or data is incorrectly written in an unselected cell. The ripple should therefore preferably be small.

In order to reduce the ripple, a filter circuit having a resistor and a capacity is conventionally disposed on the output side of the step-up circuit. When the output of the step-up circuit is fed to a load via the filter circuit, the filter circuit reduces the ripple.

However, there are two problems related to the ripple control and step-up speed. First, although when the resistance value and capacitance value are increased, the ripple is reduced, the step-up speed is slower. In the past, designing has been performed in consideration of a trade-off between the size of the ripple and the step-up speed. Secondly, the size of the ripple and the step-up speed depend on the size of the capacity of the load. When the capacity of the load is smaller, the step-up speed is faster, but the ripple size is bigger. When the capacity of the load is larger, the step-up speed is slower, but the ripple size is smaller.

A conventional power source circuit includes multiple step-up circuits that step up a voltage fed from a power supply so as to produce an output voltage, a comparator that monitors the output voltage and outputs a signal with which activation or inactivation of the step-up circuits is instructed, and a variable frequency oscillator that inputs an output of the comparator (a voltage with which an OSC control operation is performed) and outputs a clock with which the step-up circuits perform a step-up operation. The conventional power source circuit reduces the ripple of the output voltage by controlling the frequency of the clock according to the output voltages of the step-up circuits.

However, the prior art, has not succeeded in a ripple controlling a filer circuit disposed on the output side of a step-up circuit so as to raise a reset speed at which an output voltage is restored to a designated voltage while reducing a ripple.

### SUMMARY OF THE INVENTION

A power source circuit that outputs a designated voltage through an output terminal thereof, comprising: a step-up circuit that steps up a voltage fed from a power supply and applies the resultant voltage to the output terminal; a voltage sensing circuit that senses a voltage outputted from the step-up circuit and outputs a signal with which activation of the step-up circuit is controlled; and a filter circuit that includes a variable resistor connected between the output side of the step-up circuit and the output terminal.

### BRIEF DESCRIPTION OF THE DRAWINGS

FIG. 1 shows the configuration of a major portion of a power source circuit in accordance with an embodiment 1 of the present invention;

FIG. 2 shows an example of a step-up circuit to be adapted to the power source circuit shown in FIG. 1;

FIG. 3 shows an example of a filter circuit to be adapted to the power source circuit shown in FIG. 1;

FIG. 4 shows the relationship among a voltage to be outputted through an output terminal, a voltage to be outputted from a step-up circuit, and a time, which is established in a case where a voltage is applied to a load through the output terminal of the power source circuit in accordance with the embodiment 1;

FIG. 5 is a block diagram showing an example of a NAND type flash memory including the power source circuit in accordance with the embodiment 1 of the present invention;

FIG. 6 shows the configuration of a major portion of a power source circuit 300 in accordance with an embodiment 2 of the present invention;

FIG. 7 shows an example of a filter circuit to be adapted to the power source circuit shown in FIG. 6;

FIG. 8 shows the relationship among a voltage to be outputted through an output terminal, a voltage to be outputted from a step-up circuit, and a time, which is established in a case where a voltage is applied to a load, whose capacity is small, through the output terminal of the power source circuit in accordance with the embodiment 2; and

FIG. 9 shows the relationship among a voltage to be outputted through the output terminal, a voltage to be outputted from the step-up circuit, and a time, which is established in a case where a voltage is applied to a load, whose capacity is large, through the output terminal of the power source circuit in accordance with the embodiment 2.

### DETAILED DESCRIPTION OF THE INVENTION

### Embodiment 1

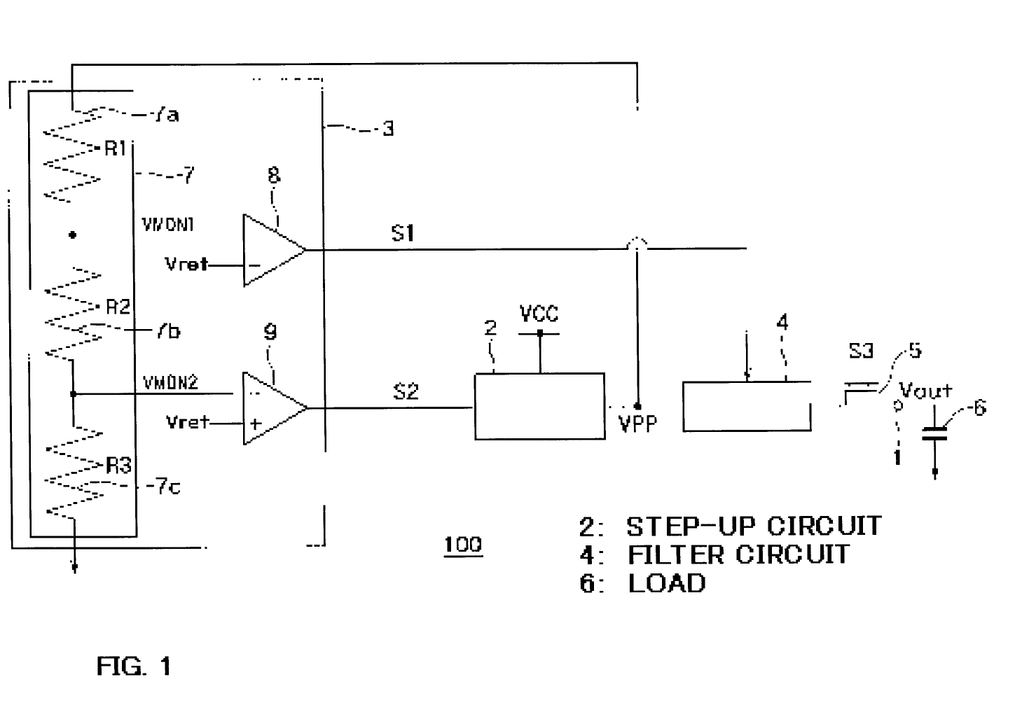

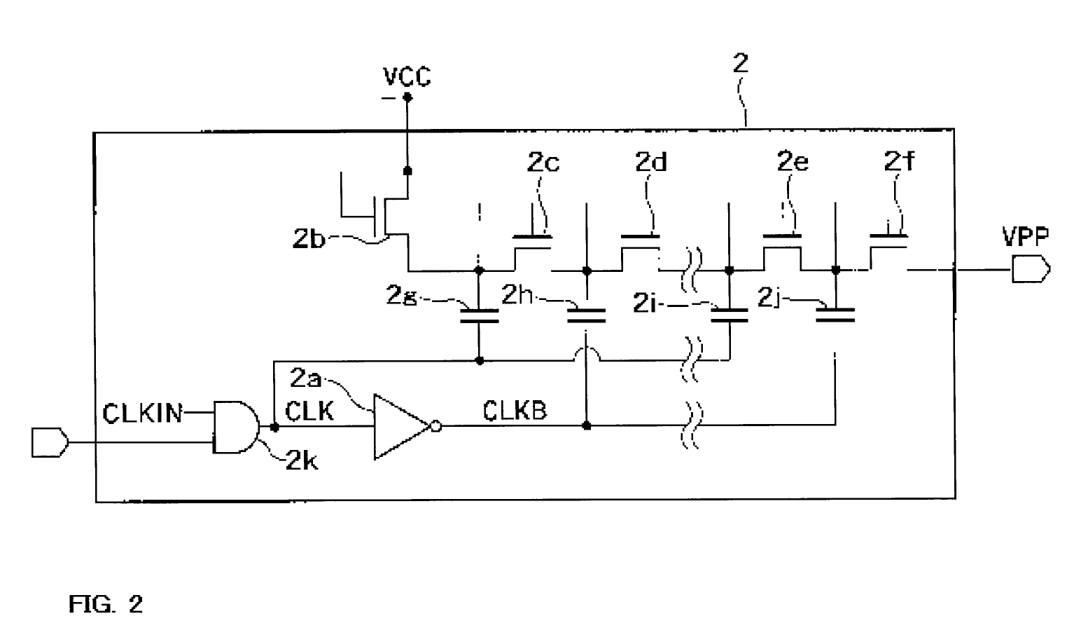

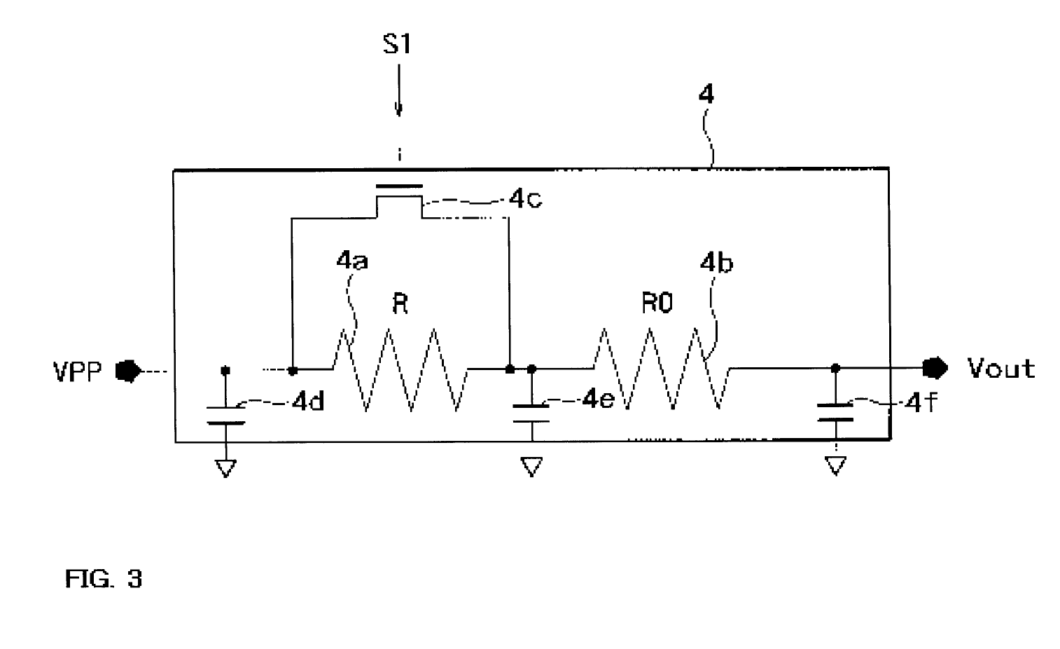

FIG. 1 shows the configuration of a major portion of a power source circuit 100 in accordance with an embodiment 1 of the present invention. Moreover, FIG. 2 shows an example of a step-up circuit to be adapted to the power source circuit shown in FIG. 1. FIG. 3 shows an example of a filter circuit to be adapted to the power source circuit shown in FIG. 1. As shown in FIG. 1, the power source circuit 100 includes: an output terminal 1 through which a designated voltage Vset is outputted; a step-up circuit 2 that steps up a voltage fed from a power supply VCC and applies the resultant voltage to the output terminal 1; a voltage sensing circuit 3 that senses a voltage VPP outputted from the step-up circuit 2 and outputs a signal with which activation of the step-up circuit 2 is controlled; a filter circuit 4 that includes a variable resistor connected between the output side of the step-up circuit 2 and the output terminal 1; and a switch circuit 5 that is connected between the output side of the filter circuit 4 and the output terminal 1. A load 6 is connected through the output terminal 1. The load 6 refers to a nonvolatile semiconductor memory unit such as an EEPROM of a NAND-cell type, a NOR-cell type, a DINOR-cell type, or an AND-cell type or a circuit that requires a voltage stepped up to be higher than the supply voltage fed from the power supply VCC. The switch circuit 5 is formed with, for example, a MOS transistor, and is turned on or off with a signal applied to the gate of the MOS transistor. By turning on or off the switch circuit, feed of a voltage from the step-up circuit 2 to the load 6 is controlled.

The step-up circuit 2 includes, for example, as shown in FIG. 2, an AND circuit 2k that inputs a reference clock CLKIN and an activation signal S2 and outputs a clock signal CLK, and an inverter circuit 2a that inputs the clock signal CLK and outputs an inverted clock signal CLKB. Further, the step-up circuit 2 includes a MOS transistor 2b having the source thereof connected to the power supply VCC and having the source and gate thereof connected to each other, MOS transistors 2c to 2f which are connected in series with one another between the drain of the MOS transistor 2b and the output terminal 1, each of which has the source and gate thereof connected to each other, and capacitors 2g to 2j that are connected to the sources of the respective MOS transistors 2c to 2f.

The clock signal CLK is inputted to the capacitors 2g and 2i, and the output side of the inverter circuit 2a is connected to the capacitors 2h and 2j. Accordingly, when an activation signal S2 (herein, a high-level signal, that is, a signal representing logical 1) is inputted to the step-up circuit 2, for example, the MOS transistors 2c to 2f are alternately activated. The capacitors 2g to 2j are sequentially charged and boosted. A stepped up voltage is then outputted as a voltage VPP.

As already described, in order to improve the performance of the step-up operation of the step-up circuit 2, the capacitance of the capacitors 2g to 2j should merely be increased. Moreover, the step-up circuit shown in FIG. 2 is a mere example. The step-up circuit employed in the present embodiment should merely step up the supply voltage VCC according to the activation signal S2, and output the resultant voltage.

Moreover, as shown in FIG. 1, the voltage sensing circuit 3 includes a voltage division circuit 7, a first comparative amplifier 8, and a second comparative amplifier 9. The voltage division circuit 7 includes a first voltage division resistor 7a having one terminal thereof connected to the output side of the step-up circuit 2, and offering a resistance R1, a second voltage division resistor 7b having one terminal thereof connected to the other terminal of the first voltage division resistor 7a, and offering a resistance R2, and a third voltage division resistor 7c having one terminal thereof connected to the other terminal of the second voltage division resistor 7b, having the other terminal thereof grounded, and offering a resistance R3. The voltage division circuit 7 divides the voltage VPP, which is outputted from the step-up circuit 2, according to a first voltage division ratio (R2+R3)/(R1+R2+R3) so as to output a first monitor voltage VMON1. Further, the voltage division circuit 7 divides the voltage VPP, which is outputted from the step-up circuit 2, according to a second voltage division ratio (R3)/(R1+R2+R3) smaller than the first voltage division ratio so as to output a second monitor voltage VMON2.

The first comparative amplifier 8 inputs the first monitor voltage VMON1 through an inverting input terminal thereof, inputs a reference voltage Vref through a noninverting input terminal thereof, and has the output side thereof connected to the filter circuit 4. In other words, the first comparative amplifier 8 compares the first monitor voltage VMON1 with the reference voltage Vref. If the first monitor voltage VMON1 is higher than the reference voltage Vref, the first comparative amplifier 8 outputs a resistance regulation signal S1 (herein, a low-level signal, that is, a signal representing logical 0). On the other hand, when the first monitor voltage VMON1 is lower than the reference voltage Vref, the first comparative amplifier 8 ceases the output of the resistance regulation signal S1 (herein, outputs a high-level signal, that is, a signal representing logical 1).

The second comparative amplifier 9 inputs the second monitor voltage VMON2 through an inverting input terminal thereof, inputs the reference voltage Vref through a noninverting input terminal thereof, and has the output side thereof connected to the step-up circuit 2. In other words, the second comparative amplifier 9 compares the second monitor voltage VMON2 with the reference voltage Vref. When the second monitor voltage VMON2 is lower than the reference voltage Vref, the second comparative amplifier 9 outputs an activation signal S2 (herein, a high-level signal, that is, a signal representing logical 1). When the second monitor voltage VMON2 is higher than the reference voltage Vref, the second comparative amplifier 9 ceases the output of the activation signal S2 (herein, outputs a low-level signal, that is, a signal representing logical 0).

The filter circuit 4 includes, as shown in FIG. 3, for example, a first resistor 4a and a second resistor 4b which constitute a variable resistor, and a MOS transistor 4c serving as a switching element. The resistances offered by the first and second resistors 4a and 4b shall have values R and R0.

The first resistor 4a and MOS transistor 4c are connected in parallel with each other between the output side of the step-up circuit 2 and the switch circuit 5. Moreover, the first resistor 4a and second resistor 4b are connected in series with each other between the output side of the step-up circuit 2 and the switch circuit 5. Moreover, the filter circuit 4 includes parasitic capacitors 4d, 4e, and 4f formed at the terminals of the first and second resistors 4a and 4b. In order to adjust the characteristic of the filter circuit 4, capacitors may be added to the terminals of the first and second resistors 4a and 4b. In this case, switching elements may be interposed between the terminals of the first and second resistors 4a and 4b and the capacitors so that the capacitors can be electrically isolated if necessary.

In the filter circuit 4, when the MOS transistor 4c inputs the resistance regulation signal S1 (herein, a low-level signal, that is, a signal representing logical 0) through the gate thereof, the MOS transistor 4c is turned off, and the resistance of the variable resistor is regulated to change from the value R0 to a value R0+R, that is, to increase.

Incidentally, when the resistance regulation signal S1 is not outputted from the first comparative amplifier 8, the high-level signal outputted from the first comparative amplifier 8, that is, the signal representing logical 1 is applied to the gate of the MOS transistor 4c. The MOS transistor 4c is then turned on. Consequently, the resistance of the variable resistor is regulated to change from the value R0+R to the value R0, that is, to decrease.

Now, the step-up operation of the power source circuit 100 having the foregoing components will be described below.

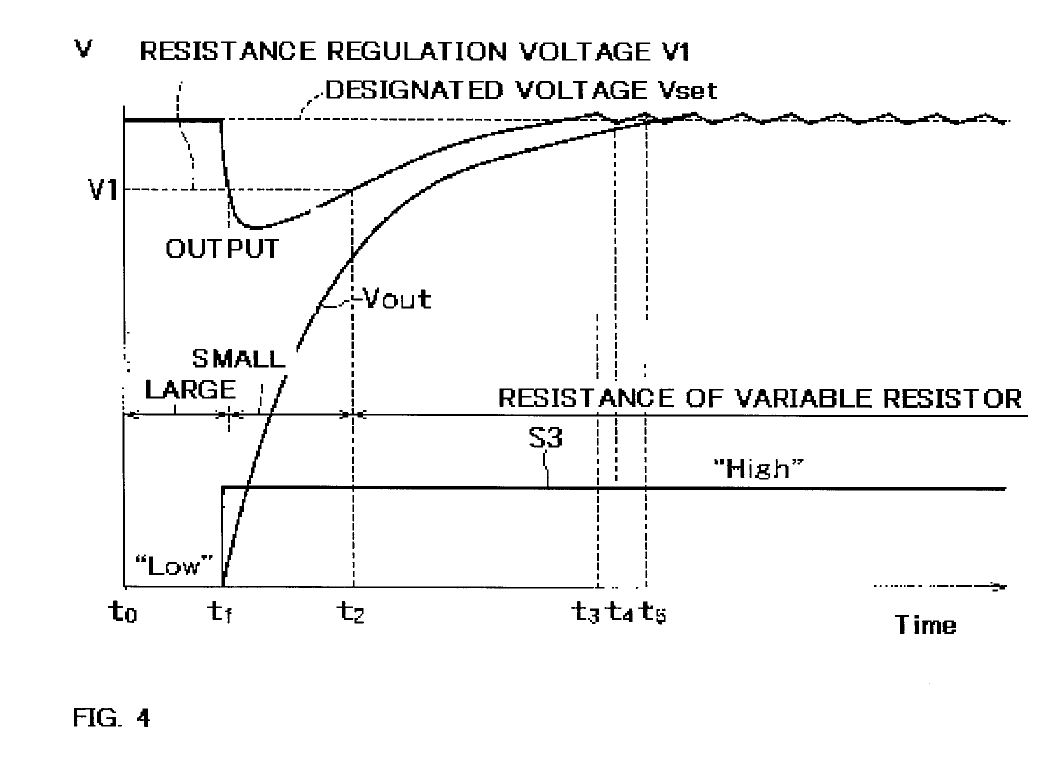

FIG. 4 shows the relationship among a voltage to be outputted through the output terminal, a voltage to be outputted from the step-up circuit, and a time which is established in a case where a voltage is fed to the load through the output terminal of the power source circuit in accordance with the embodiment 1. To begin with, when the voltage sensing circuit 3 senses that the voltage VPP outputted from the step-up circuit 2 falls below the designated voltage Vset, the voltage sensing circuit 3 outputs the activation signal S2 (herein, a high-level signal, that is, a signal representing logical 1) with which the step-up circuit 2 is activated. Consequently, the step-up circuit 2 is activated to initiate a step-up operation, and the voltage VPP rises up to the designated voltage Vset (time to). When the switch circuit 5 is turned on responsively to the signal S3, the output side of the filter circuit 4 conducts to the load 6. The output voltage Vout at the output terminal 1 rises (time t1). When the voltage sensing circuit 3 senses that the voltage VPP outputted from the step-up circuit 2 falls below the resistance regulation voltage V1 set to a voltage lower than the designated voltage Vset, the voltage sensing circuit 3 dose not output the resistance regulation signal S1 with which the resistance of the variable resistor is increased. In other words, when the step-up circuit 2 initiates the step-up operation, since the voltage VPP is low, the resistance regulation signal S1 is not outputted but the MOS transistor 4c is turned on. Consequently, the resistance of the variable register is set to the value R0 (or decreases), the step-up speed for the output voltage Vout at the output terminal 1 is raised.

On the other hand, when the voltage sensing circuit 3 senses that the voltage VPP outputted from the step-up circuit 2 is equal to or higher than the resistance regulation voltage V1, the voltage sensing circuit 3 outputs the resistance regulation signal S1 (herein, a low-level signal, that is, a signal representing logical 0) (from a time t2). In other words, when the voltage VPP becomes equal to or higher than the resistance regulation voltage V1, the first comparative amplifier 8 outputs the resistance regulation signal S1, and the MOS transistor 4c is turned off. Consequently, the resistance of the variable resistor is set to the value R0+R1 (increases), and the effect of suppressing the ripple of the output voltage Vout at the output terminal 1 is improved.

The voltage sensing circuit 3 senses that the voltage VPP outputted from the step-up circuit 2 is equal to or higher than the designated voltage Vset, the voltage sensing circuit 3 ceases the output of the activation signal S2 (herein, outputs a low-level signal, that is, a signal representing logical 0). Consequently, the step-up circuit 2 is inactivated and ceases the step-up operation thereof. The voltage VPP therefore drops (times t3 and t4). When the voltage sensing circuit 3 senses that the voltage VPP outputted from the step-up circuit 2 falls below the designated voltage Vset again, the voltage sensing circuit 3 re-outputs the activation signal S2. Consequently, the step-up circuit 2 is activated again, and initiates the step-up operation. The voltage VPP therefore rises (times t4 and t5). Thereafter, the same operations of the voltage sensing circuit 3 and step-up circuit 2 are repeated.

As shown in FIG. 4, a ripple pertains to vibrations occurring around the designated voltage Vset. When the step-up operation is initiated in order to step up the voltage VPP toward the designated voltage Vset, the ripple need not be taken into consideration. Therefore, the resistance of the variable resistor in the filter circuit 4 is decreased, and the step-up speed is given priority. On the other hand, when the voltage VPP gets close to the designated voltage Vset, the resistance of the variable resistor in the filter circuit 4 is increased in order to reduce the ripple.

Now, a case where the power source circuit 100 having the foregoing components and capability is adapted to a NAND type flash memory will be described below.

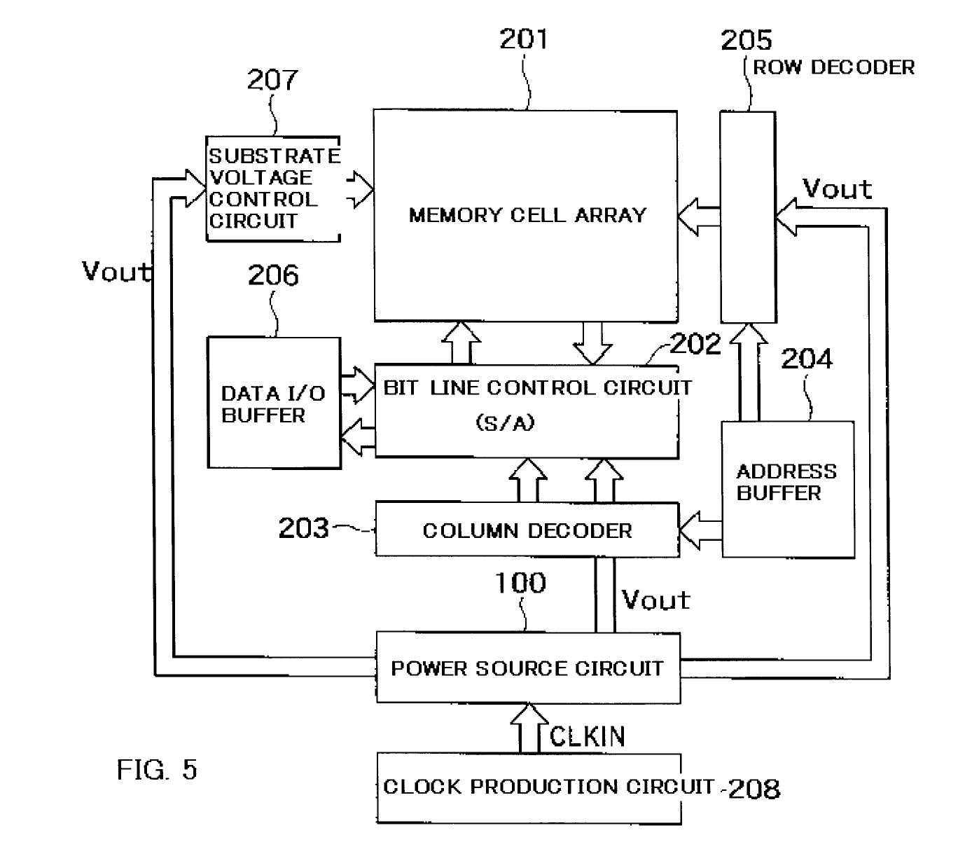

FIG. 5 is a block diagram showing an example of a NAND type flash memory including the power source circuit in accordance with the embodiment 1 of the present invention. As shown in FIG. 5, a semiconductor memory unit 200 that is the NAND type flash memory includes a bit line control circuit 202 that writes or reads data in or from a memory cell array 201 that is memory means. The bit line control circuit 202 is connected to a data input/output buffer 206. The bit line control circuit 202 receives an output of a column decoder 203, which receives an address signal from an address buffer 204, as an input.

Moreover, a row decoder 205 that controls a control gate and a selection gate is connected to the memory cell array 201, and a substrate voltage control circuit 207 that controls a voltage at a p-type substrate (or a p-type well) in which the memory cell array 201 is formed is connected to the memory cell array 201. Further, the semiconductor memory unit 200 includes a clock production circuit 208 and the power source circuit 100 in accordance with the present embodiment.

The power source circuit 100 feeds an output voltage VPP to the bit line control circuit 202, row decoder 205, and substrate voltage control circuit 207 at the time of reading, writing, or erasing data from, in, or from the memory cell array 201. As mentioned above, the power source circuit 100 can feed the output voltage VPP, which has the ripple thereof reduced, to these circuit elements. According to the semiconductor memory unit 200 having the foregoing components, for example, in the operation of writing data in a cell of the NAND type flash memory, a ripple occurring on a word line on which a selected cell and unselected cells are connected can be reduced, the threshold voltage of the written cell can be narrowed, and incorrect writing in an unselected cell can be minimized. As mentioned above, according to the power source circuit of the present embodiment, a reset speed at which an output voltage is restored to a designated voltage can be raised, and the ripple can be reduced.

### Embodiment 2

In the embodiment 1, a description has been made of the constitution that regulates the resistance of the variable resistor in the filter circuit according to the output of the step-up circuit. In the present embodiment, a description will be made of the constitution that regulates the resistance of the variable resistor in the filter circuit according to the size of a load connected through the output terminal.

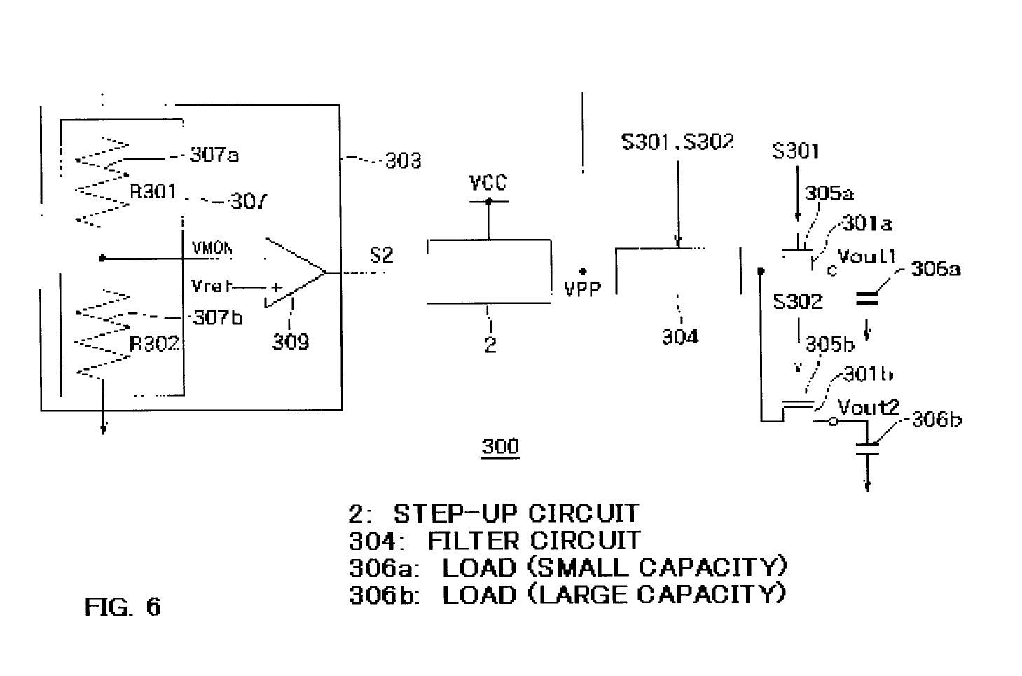

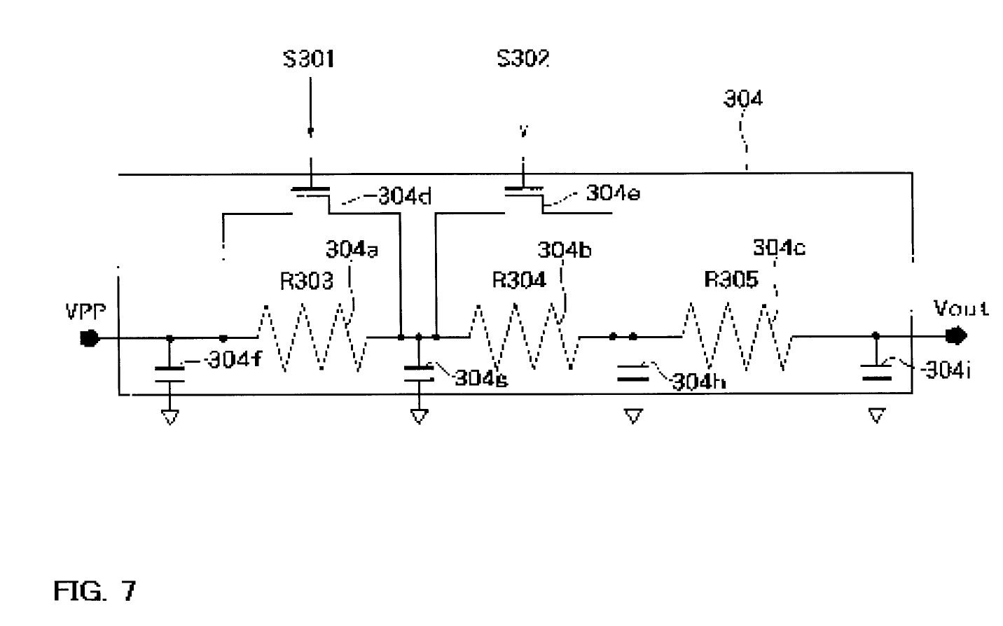

FIG. 6 shows the configuration of a major portion of a power source circuit 300 in accordance with the embodiment 2 of the present invention. FIG. 7 shows an example of a filter circuit to be adapted to the power source circuit shown in FIG. 6. Incidentally, components to which the same reference numerals as those of the embodiment 1 are identical to the components of the embodiment 1. As shown in FIG. 6, the power source circuit 300 includes a first output terminal 301a through which a designated voltage Vset is outputted, and a second output terminal 301b through which the designated voltage Vset is outputted. Moreover, the power source circuit 300 includes a step-up circuit 2 that steps up a voltage fed from a power supply VCC and applies the resultant voltage to the first and second output terminals 301a and 301b, a voltage sensing circuit 303 that senses a voltage VPP outputted from the step-up circuit and outputs a signal with which activation of the step-up circuit 2 is controlled, and a filter circuit 304 that includes a variable resistor and is connected between the output side of the step-up circuit 2 and the first and second output terminals 301a and 301b.

Moreover, the power source circuit 300 includes a first switch circuit 305a connected between the output side of the filter circuit 304 and the first output terminal 301a, and a second switch circuit 305b connected between the output side of the filter circuit 304 and the second output terminal 301b.

A first load 306a is connected through the first output terminal 301a. A second load 306b whose capacity is larger than that of the first load 306a is connected through the second output terminal 301b. The first and second loads 306a and 306b refer to nonvolatile semiconductor memory units such as EEPROMs of a NAND cell type, a NOR cell type, a DINOR cell type, or an AND cell type, or circuits that require a voltage stepped up to be higher than a supply voltage VCC. The first switch circuit 305a is formed with, for example, a MOS transistor. The MOS transistor is turned on or off in response to a first switching signal S301 that is applied to the gate thereof. By turning on or off the MOS transistor, feed of a voltage from the step-up circuit 2 to the first load 306a is controlled.

The second switch circuit 305b is formed with, for example, a MOS transistor. The MOS transistor is turned on or off in response to a second switching signal S302 that is applied to the gate thereof. By turning on or off the MOS transistor, feed of a voltage from the step-up circuit 2 to the second load 306b is controlled.

In the present embodiment, when the first switching signal S1 has a high level, the second switching signal S2 has a low level. When the first switching signal S1 has the low level, the second switching signal S2 has the high level. Namely, the first switch circuit 305a and second switch circuit 305b are complementarily turned on or off.

Moreover, the voltage sensing circuit 303 includes a voltage division circuit 307 and a comparative amplifier 9. The voltage division circuit 307 includes a first voltage division resistor 307a that has one terminal thereof connected to the output side of the step-up circuit 2 and offers a resistance R301, and a second voltage division resistor 307b that has one terminal thereof connected to the other terminal of the first voltage division resistor 307a, has the other terminal thereof grounded, and offers a resistance R302. The voltage division circuit 307 divides the voltage VPP, which is outputted from the step-up circuit 2, according to a voltage division ratio (R302)/(R301+R302) so as to output a monitor voltage VMON.

The comparative amplifier 309 inputs the monitor voltage VMON through an inverting input terminal thereof, inputs a reference voltage Vref through a noninverting input terminal thereof, and has an output side thereof connected to the step-up circuit 2. Namely, the comparative amplifier 309 compares the monitor voltage VMOn with the reference voltage Vref. When the monitor voltage VMON is lower than the reference voltage Vref, the comparative amplifier 309 outputs an activation signal S2 (herein, a high-level signal, that is, a signal representing logical 1). On the other hand, when the monitor voltage VMON is higher than the reference voltage Vref, the comparative amplifier 309 ceases the output of the activation signal S2 (herein, outputs a low-level signal, that is, a signal representing logical 0).

The filter circuit 304 includes, as shown in FIG. 7, for example, a first resistor 304a, a second resistor 304b, and a third resistor 304c which constitute a variable resistor, and a first MOS transistor 4d and a second MOS transistor 4e which are switching elements. The resistances of the first resistor 304a, second resistor 304b, and third resistor 304c respectively shall assume values R303, R304, and R305 respectively. Moreover, the resistance value R303 is smaller than the resistance value R304.

The first resistor 304a and first MOS transistor 304d are connected in parallel with each other between the output side of the step-up circuit 2 and the first and second switch circuits 305a and 305b. Moreover, the second resistor 304b and second MOS transistor 304e are connected in parallel with each other between the output side of the step-up circuit 2 and the first and second switch circuits 305a and 305b. Moreover, the first resistor 304a, second resistor 304b, and third resistor 304c are connected in series with one another between the output side of the step-up circuit 2 and the first and second switch circuits 305a and 305b.

Moreover, the filter circuit 304 includes parasitic capacitors 304f, 304g, 304h, and 304i at the terminals of the first to third resistors 304a to 304c. In order to adjust the characteristic of the filter circuit 304, capacitors may be added to the terminals of the first to third resistors 304a to 304c. In this case, switching elements may be interposed between the terminals of the first to third resistors 304a to 304c and the capacitors so that the capacitors can be electrically isolated if necessary.

When a voltage is fed to the second load 306b whose capacity is larger, the step-up speed is lowered and the ripple of the voltage to be fed is reduced. Consequently, the resistance of the variable resistor in the filter circuit 304 may presumably be small. On the other hand, when a voltage is fed to the first load 306a whose capacity is smaller, the step-up speed is raised and the ripple of the voltage to be fed is increased. Consequently, the resistance of the variable resistor in the filter circuit 304 should presumably be increased.

The first and second switching signals S301 and S302 are controlled so that the first switching signal S301 will have a low level and the second switching signal S302 will have a high level. Consequently, the first switch circuit 305a and first MOS transistor 304d are turned off, and the second switch circuit 305b and second MOS transistor 304e are turned on. Eventually, a voltage is fed to the second load 306b, and the resistance of the variable resistor is set to a value (R303+R305), that is, is regulated to decrease. On the other hand, when the first switching signal S301 has the high level and the second switching signal S302 has the low level, the first switch circuit 305a and first MOS transistor 304d are turned on, and the second switch circuit 305b and second MOS transistor 304e are turned off. Consequently, a voltage is fed to the first load 306a, and the resistance of the variable resistor is set to a value (R304+R305), that is, is regulated to increase.

As mentioned above, in the present embodiment, when the capacity of a load which is connected through the output terminal and to which a voltage is fed is small, the resistance of the variable resistor in the filter circuit is set to a large value. On the other hand, when the capacity of a load which is connected through the output terminal and to which a voltage is fed is large, the resistance of the variable register is set to a small value. Owing to such control, an increase in a ripple dependent on the capacity of a load can be suppressed without a decrease in a step-up speed.

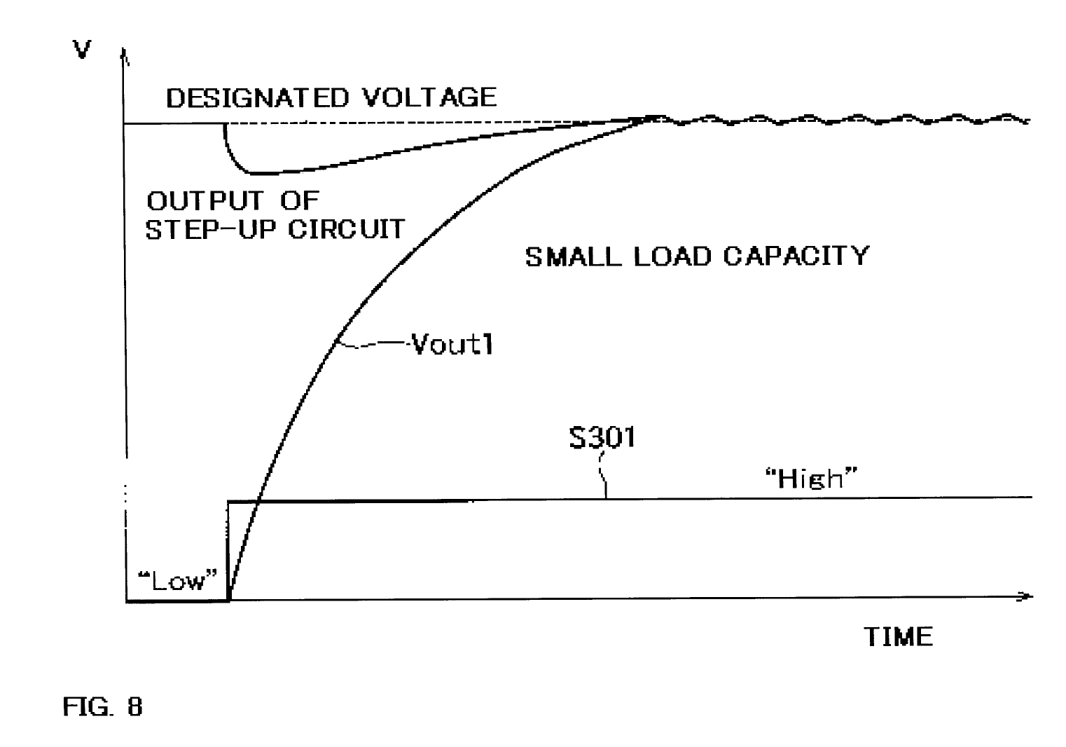

FIG. 8 shows the relationship of a voltage to be outputted through the output terminal and a voltage to be outputted from the step-up circuit to a time which is established in a case where a voltage is fed to a load, whose capacity is small, through the output terminal of the power source circuit in accordance with the embodiment 2. When the capacity of the load is small, a ripple may increase. However, when the resistance of the variable resistor in the filter circuit is set to a large value, an increase in the ripple can be suppressed. Since the capacity of the load is small, the step-up speed is high. Therefore, even when the resistance is increased in order to increase a magnitude of delay, there would be no problem.

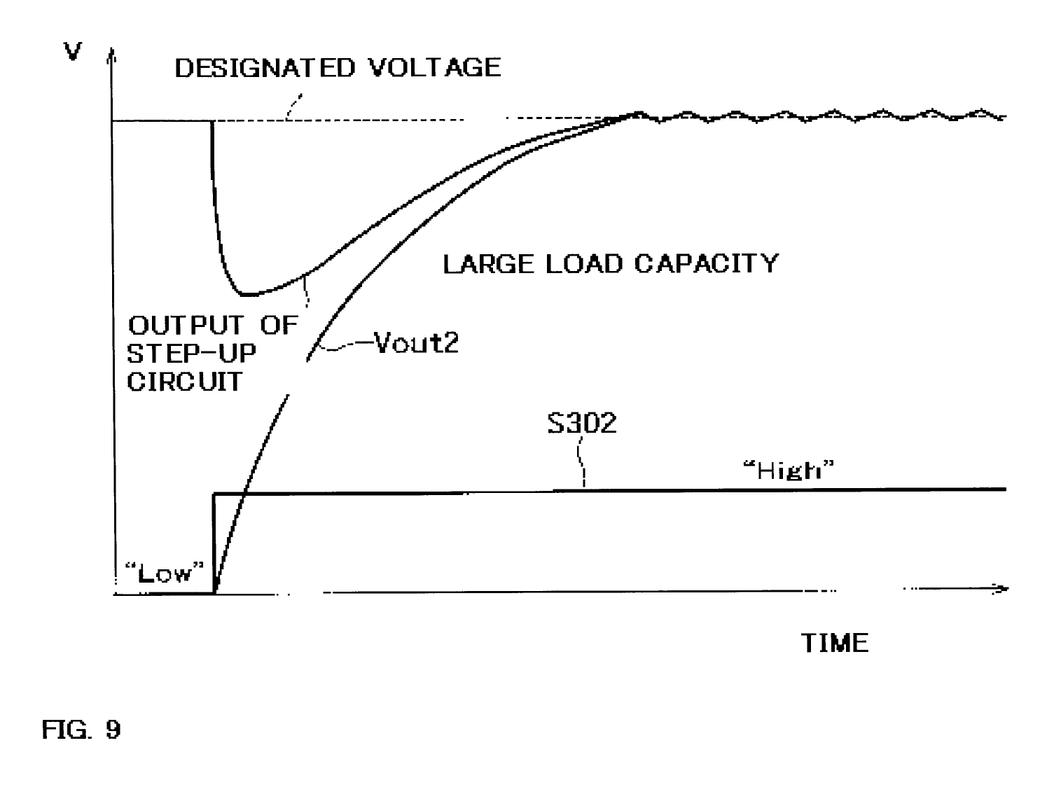

FIG. 9 shows the relationship of a voltage to be outputted through the output terminal and a voltage to be outputted from the step-up circuit to a time, which is established in a case where a voltage is fed to a load, whose capacity is large, through the output terminal of the power source circuit in accordance with the embodiment 2. When the capacity of the load is large, a ripple is small. Therefore, the resistance of the variable resistor in the filter circuit is set to a small value in order to increase a step-up speed. As already mentioned, since the ripple is small, an increase in the ripple derived from the small resistance value would pose no problem.

As mentioned above, according to the power source circuit of the present embodiment, while a reset speed at which an output voltage is restored to a designated voltage is raised, a ripple can be reduced. Even the power source circuit 300 in accordance with the embodiment 2 can be, similarly to that of the embodiment 1, adapted to the semiconductor memory unit 200 shown in FIG. 5.

Moreover, in the embodiment 2, a description has been made of a case where the number of loads is two and a voltage is fed to the loads while the loads are complementarily switched, however a voltage may be simultaneously fed to the two loads. Moreover, three or more loads may be connected, and a voltage may be fed to each of the loads.

The present invention is not limited to the above-described embodiments, and various modifications may be made to the respective constituent elements without departing from the subject matter of the present invention. Various embodiments may be constructed by properly combining plural constituent elements disclosed in the above-described embodiments. For example, some constituent elements may be deleted from all the constituent elements disclosed in the above-described embodiments, or constituent elements of different embodiments may be properly combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A power source circuit that outputs a designated voltage through an output terminal thereof, comprising:
a step-up circuit that steps up a voltage fed from a power supply and applies the resultant voltage to the output terminal;
a voltage sensing circuit that senses a voltage outputted from the step-up circuit and outputs a signal with which activation of the step-up circuit is controlled; and
a filter circuit that includes a variable resistor connected between the output side of the step-up circuit and the output terminal.

2. The power source circuit according to claim 1, wherein:
when the voltage sensing circuit senses that the voltage outputted from the step-up circuit is equal to or higher than a resistance regulation voltage which is set to be lower than the designated voltage, the voltage sensing circuit outputs a resistance regulation signal with which the resistance of the variable resistor is increased;
when the voltage sensing circuit senses that the voltage outputted from the step-up circuit falls below the designated voltage, the voltage sensing circuit outputs an activation signal with which the step-up circuit is activated; and
when the voltage sensing circuit senses that the voltage outputted from the step-up circuit is equal to or higher than the designated voltage, the voltage sensing circuit ceases the output of the activation signal.

3. The power source circuit according to claim 2, wherein the filter circuit increases the resistance of the variable resistor thereof according to the resistance regulation signal, and the step-up circuit is activated in response to the activation signal.

4. The power source circuit according to claim 3, wherein the voltage sensing circuit includes:
a voltage division circuit that divides a voltage, which is outputted from the step-up circuit, according to a first voltage division ratio so as to output a first monitor voltage, and that divides the voltage, which is outputted from the step-up circuit, according to a second voltage division ratio smaller than the first voltage division ratio so as to output a second monitor voltage;
a first comparative amplifier that compares the first monitor voltage with a reference voltage, and outputs the resistance regulation signal if the first monitor voltage is higher than the reference voltage; and
a second comparative amplifier that compares the second monitor voltage with the reference voltage, and outputs the activation signal if the second monitor voltage is lower than the reference voltage, while ceases the output of the activation signal if the second monitor voltage is higher than the reference voltage.

5. The power source circuit according to claim 1, wherein:
when the capacity of a load which is connected through the output terminal and to which a voltage is fed is small, the filter circuit increases the resistance of the variable resistor thereof;
when the capacity of the load which is connected through the output terminal and to which a voltage is fed is large, the filter circuit decreases the resistance of the variable resistor thereof.

6. The power source circuit according to claim 5, further comprising:
a first switch circuit that is connected between the output side of the filter circuit and a first output terminal through which a first load is connected, and that is turned on or off in response to a first switching signal; and
a second switch circuit that is connected between the output side of the filter circuit and a second output terminal through which a second load whose capacity is larger than that of the first load is connected, and that is turned on or off in response to a second switching signal, wherein:
the filter circuit regulates the resistance of the variable resistor thereof according to the first or second switching signal.

7. A method of driving a power source circuit that outputs a designated voltage through an output terminal thereof, and includes: a step-up circuit which steps up a voltage fed from a power supply and applies the resultant voltage to the output terminal; a voltage sensing circuit which senses a voltage outputted from the step-up circuit and outputs a signal with which activation of the step-up circuit is controlled; and a filter circuit that includes a variable resistor connected between the output side of the step-up circuit and the output terminal, wherein:
when the voltage sensing circuit senses that the voltage outputted from the step-up circuit is equal to or higher than a resistance regulation voltage which is set to be lower than the designated voltage, the voltage sensing circuit outputs a resistance regulation signal with which the resistance of the variable resistor is increased;
when the voltage sensing circuit senses that the voltage outputted from the step-up circuit falls below the designated voltage, the voltage sensing circuit outputs an activation signal with which the step-up circuit is activated; and
when the voltage sensing circuit senses that the voltage outputted from the step-up circuit is equal to or higher than the designated voltage, the voltage sensing circuit ceases the output of the activation signal.

8. The method of driving a power source circuit according to claim 7, wherein the filter circuit increases the resistance of the variable resistor thereof according to the resistance regulation signal, and the step-up circuit is activated in response to the activation signal.

9. The method of driving a power source circuit according to claim 8, wherein the voltage sensing circuit includes:
a voltage division circuit that divides a voltage, which is outputted from the step-up circuit, according to a first voltage division ratio so as to output a first monitor voltage, and that divides the voltage, which is outputted from the step-up circuit, according to a second voltage division ratio smaller than the first voltage division ratio so as to output a second monitor voltage;
a first comparative amplifier that compares the first monitor voltage with a reference voltage and outputs the resistance regulation signal if the first monitor voltage is higher than the reference voltage; and
a second comparative amplifier that compares the second monitor voltage with the reference voltage, and outputs the activation signal if the second monitor voltage is lower than the reference voltage, while ceases the output of the activation signal if the second monitor voltage is higher than the reference voltage.

10. The method of driving a power source circuit according to claim 9, wherein:
when the capacity of a load which is connected through the output terminal and to which a voltage is fed is small, the filter circuit increases the resistance of the variable resistor thereof; and
when the capacity of the load which is connected through the output terminal and to which a voltage is fed is large, the filter circuit decreases the resistance of the variable resistor thereof.

11. The method of driving a power source circuit according to claim 10, further comprising:
a first switch circuit that is connected between the output side of the filter circuit and a first output terminal through which a first load is connected, and that is turned on or off in response to a first switching signal; and
a second switch circuit that is connected between the output side of the filter circuit and a second output terminal through which a second load whose capacity is larger than that of the first load is connected, and that is turned on or off in response to a second switching signal, wherein:
the filter circuit regulates the resistance of the variable resistor thereof according to the first or second switching signal.
